(19) United States
(12) Patent Application Publication
(10) Pub. No.: US 2003/0061012 A1
(43) Pub. Date: Mar. 27, 2003

(54) Method and system for performing four-dimensional, multiple consequence assessments of change in selected spaces

(76) Inventors: Wilson W Orr, Dewey, AZ (US); Craig H Martinsen, Prescott, AZ (US); Hoyt Johnson III, Prescott, AZ (US)

Correspondence Address: Fleshner & Kim, P O Box 221200, Chantilly, VA, 20153-1200, US

(21) Appl. No.: 10/111,539

(22) PCT Filed: Dec. 19, 2001
(86) PCT No.: PCT/US01/45859

(51) Int. Cl. G06F 17/50

(52) U.S. Cl. 703/1

(57) ABSTRACT

The present invention relates to a method of providing or updating a digital comprehensive plan for past, present and/or future community development or planning that is self-contained and capable of direct updating by inputting data into an interface control module, processing the data using the interface control module, developing digital models of at least one scenario based upon the processed data, and producing representative models of digital models.

### BACKGROUND OF THE INVENTION

1. Field of the Invention

A method for modeling a community, region, watershed or legal authority as a space-time model in 4-dimensions to assess a range of potential consequences in response to a range of potential or current actions or policy changes.

2. BACKGROUND OF THE RELATED ART

Planning for jurisdictions, legal authorities, and land use has generally involved a compilation of printed and digitized documents to represent a desired future for a place with the intent that this document based compilation could be used to guide activity for the location in question toward a particular desired future status. In the past, such a compilation would have to be reissued, at considerable expense, every 5 to 20 years or at any time that public controversy over changes in the community mandated a new plan. Additionally, any deviations from this plan, such as zoning variances, changes to base zoning, and/or plans for specific development projects would also require an update to the compilation for proper planning. Absent a full document update, these deviations in base conditions or attributes were not incorporated in the planning documentation. Further, as incremental deviations would aggregate over time, then unintended consequences, such as the occurrence of an undesirable configuration or land use pattern for the community or space under consideration, would result.

While these plans were capable of compiling useful information, many problems arose including high initial cost of producing an electronic version of a generalized general plan, as well as high maintenance costs to keep the plan current (because the plan is database resident and data must be manually grouped using poorly defined criteria to produce the plan), difficult user interfaces, and decreasing value of the plan over time (absent costly maintenance). Eventually such plans would fail to accommodate the integrated needs of entities. Further, such plans often failed to specifically accommodate above/below ground impacts of activities on the surface of the ground, or to provide a methodology for the plan to self-teach or incorporate preferences, such as those gathered from repeated interactions with user(s).

Additionally, such plans do not have the capability to determine attribute values which optimize conditions for an evaluation assessment criteria such as overall quality of life for a jurisdiction or legal authority. They also fail to provide for an assessment of the impacts of change on resource flow, or set or identify limits for the impacts of change, e.g., water use/availability ratios thus assisting in determining the limiting factors for growth in a given space. Therefore, such plans were rarely adopted by municipalities, jurisdictions, planning agencies or other potential users.

The present invention avoids the above-discussed shortcomings and provides a different, simpler, comprehensive and more cost effective approach to producing a plan to guide decisions affecting the future of a given space.

All references in this application are incorporated herein by reference to provide, if appropriate, teachings of additional or alternative details, features and/or technical background.

### SUMMARY OF THE INVENTION

An object of the invention is to solve at least the above problems and/or disadvantages and to provide at least the advantages described hereinafter. Another object of this invention is to provide a method for producing a computer-resident model of a comprehensive, strategic or general plan by embodying the plan mathematically as an assembly of attributes, relationships, and external factors which may define and/or impact a 3 dimensional space over a range of times and a range of potential changes in the attributes, or by embodying the plan as relationships among attributes and external impacts on the plan over time to produce future space-time plan scenarios.

Another object of this invention is to provide a single user interface module that accesses and controls any or all of the other modules.

Another object of this invention is to provide a learning method from which repeated user interactions allow a model to teach itself regarding user-preferred outcomes.

A further object of this invention is to incorporate the self-teaching capability into a plan scenario building process.

Another object of this invention is to store data directly in plan models that can be controlled by an Interface Control Module thus not requiring any re-input of data or any manual construction of routings for automatic data ingestion.

Another object of this invention is to provide an easy-to-use user interface for the plan models in the form of a suite of Graphical User Interfaces.

Another object of this invention is to automatically generate Virtual Comprehensive Plan (VComP) digital models which can link a description of the future of a planning domain directly to decisions made or considered in the present.

Another object of this invention is to provide a planning methodology that is completely model-based and uses space-time attributes and relationships between the space and time, as well as external factors as computational bases for creating plan scenarios.

Another object of this invention is to provide preferences of users within the method of the present invention through a learning process that can track user choices and can record these choices in an optimization plan model.

Another object of this invention is to provide the user with an optimization function which provides an optional step that allows the system running the method to generate a decision based on a user's preferences to produce an automatically generated outcome.

Another object of this invention is to accommodate above or below ground attributes, relationships among 3 dimensional attributes and external impacts and to project future attribute values based upon learned or human input relationship algorithms.

Another object of this invention is to produce nested models for a region with submodels for smaller areas within a larger area.

Another object of this invention is to provide an aggregate of integrated consequences of incremental decisions into scenario projections over a selected time for a given space or community.

Another object of this invention is to provide a method for producing a plan representation using appropriate communication media of a number of VComPs.

Another object of this invention is to produce Digital Comprehensive Plan (DComP) representative models from computer-resident VComP digital models for review and use in decision making processes.

Another object of this invention is to provide a method for users to compare, rank and select from a number of DComP representative models, where a specific DComP representative model can be used to represent a preferred future which may then be adopted as the plan for any decisions, actions, growth, development or other changes to a given spatial domain, legal authority or jurisdiction.

Another object of this invention is to have an element of a VComP digital model be able to learn a range of preferred attributes, relationships and responses to external factors and by repeated use and updating to become knowledgeable in the preferences of a particular user and automatically evaluate, rate and/or discard future space-time scenarios which lie outside the preference envelope of the user group.

Another object of this invention is to produce a four-dimensional DComP representative model by engendering repeated assessments at the surface and/or below ground and/or above ground over selected time periods.

Another object of this invention is to permit a user to set limits or thresholds for individual or multiple attributes or relationships for a space.

Another object of this invention is to identify situations when preset limits or thresholds, represented as attributes or relationships, might be exceeded, then providing indications of these situations to a User for a space.

Another object of this invention is to provide a model which will optimize attributes, factors and relationships which can present the situations when preset limits are exceeded for individual or multiple attributes.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a flow chart of a preferred embodiment of the present invention.

FIG. 1A illustrates an alternative preferred embodiment of the present invention.

FIG. 1B illustrates optional elements that can be included with a preferred embodiment of the present invention.

FIG. 2 illustrates optional Graphical User Interface subsystems of an optional Interface Control Module (ICM) 200.

FIG. 3 illustrates optional VComP 300 and DComP 400 interface subsystems of the optional ICM 200.

FIG. 4 illustrates a possible method by which interfaces and modules of an ICM 200 can communicate with a DComP Module 400 and an Optimization Interface 207.

FIG. 5 illustrates a possible method by which interfaces and modules of an ICM 200 can communicate with Optimization Module 600 through an Optimization Interface 207.

FIG. 6 illustrates a preferred embodiment of a VComP Module 300 of the present invention.

FIG. 7 illustrates a preferred embodiment of a DComP Module 400 of the present invention.

FIG. 8 illustrates a preferred embodiment of a Final Output Module 500 of the present invention.

FIG. 9 illustrates a preferred embodiment of a Optimization Module 600 of the present invention.

FIG. 10 illustrates a preferred embodiment of a Review Module 700 of the present invention.

### DETAILED DESCRIPTION OF PREFERRED EMBODIMENTS

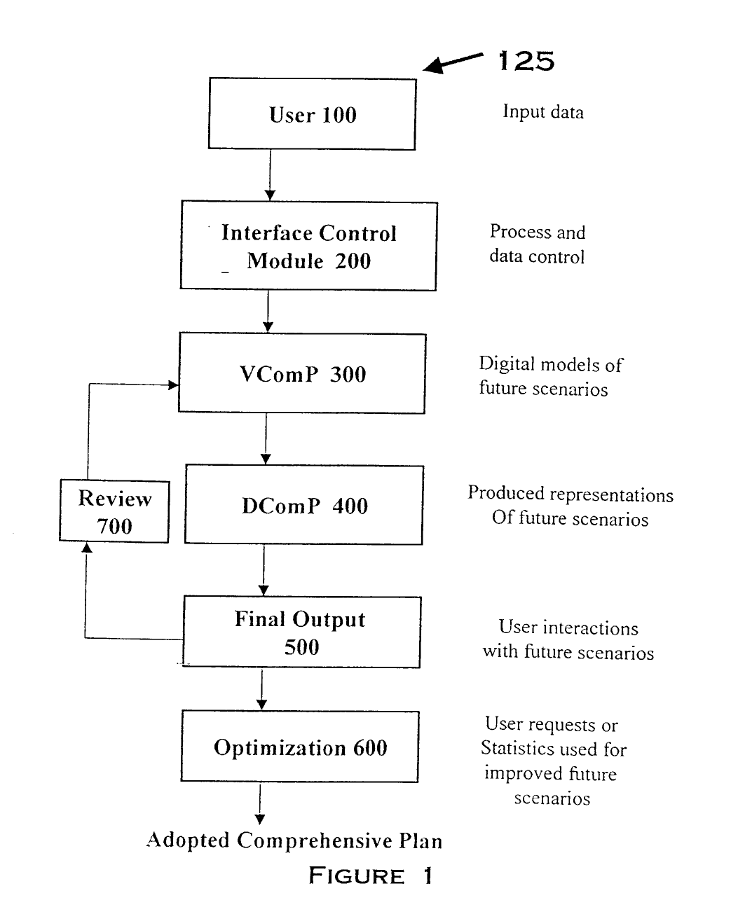

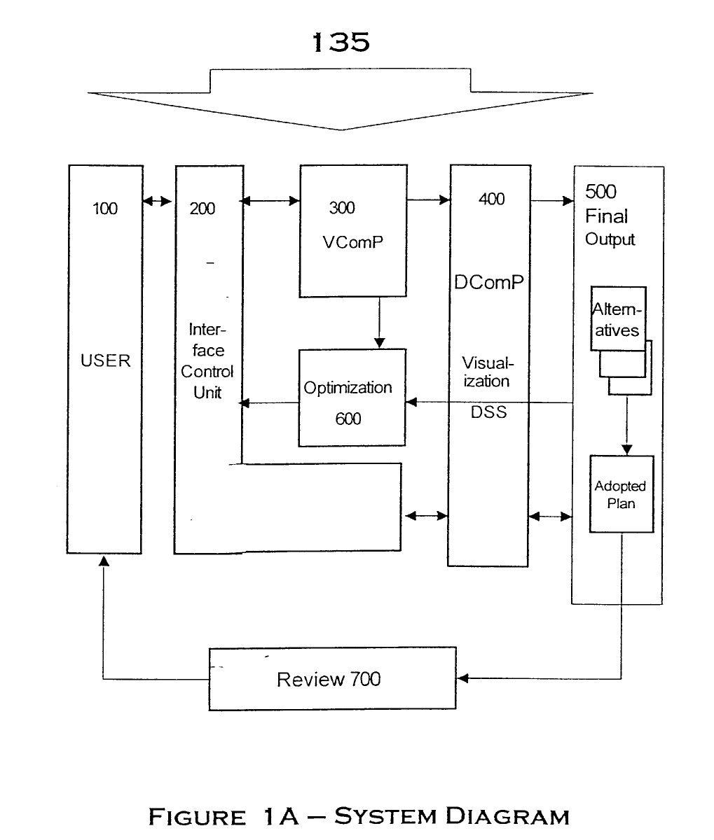

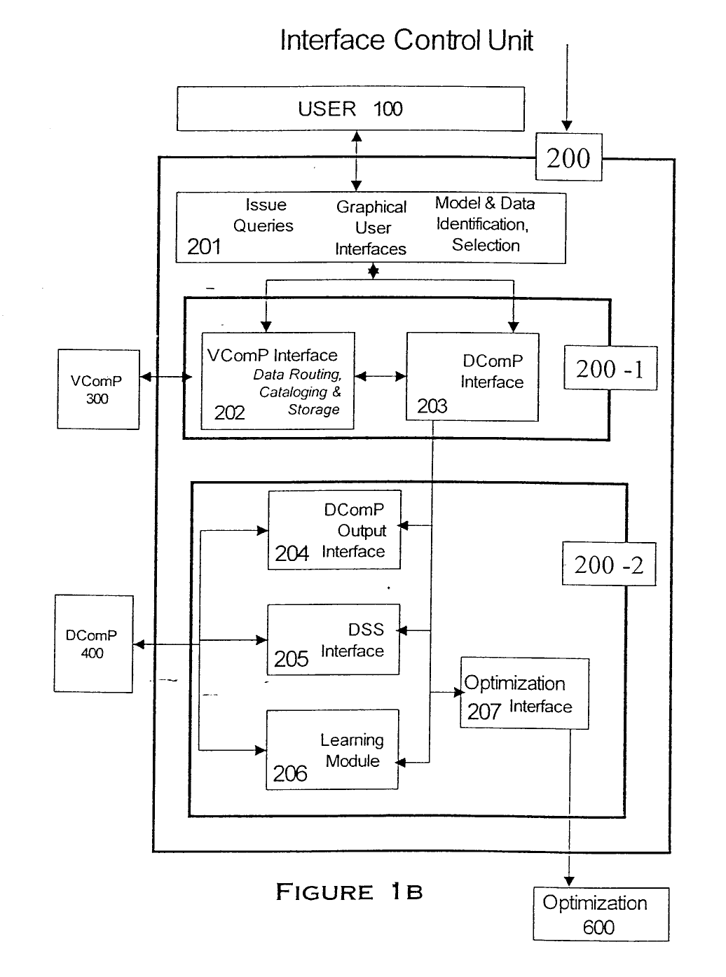

In FIGS. 1, 1A and 1B, a preferred embodiment of the present invention is illustrated for providing a self-teaching method and system for modeling, updating, or representing mathematically, a community, region, watershed or legal authority as a space-time past, present and/or future model in 4-dimensions. The method 125 and system 135 assess a range of potential past, present, and/or future consequences in response to a range of potential past, present, and/or future actions to produce a preferred Digital Comprehensive Plan (DComP) representative model. Additionally, past and/or present scenarios can be used to enable calibration of the system by determining how accurately past/present conditions may be represented by the system. As used herein, unit or module can be used interchangeably, it being understood that a software module is a specific example of the more general unit and hence, module is not limited to software. Other examples of units or modules include separate or integrated computer hardware devices and/or processors, firmware, etc. Also, communicatively coupled as used herein can include hardware connections between two such units, software communication between software modules, or any other combination thereof

A preferred embodiment of the present invention can use a self teaching system (“system”) which allows a User 100 to be able to input various types of information through an Interface Control Module (ICM) 200. The information can then be subjected to a variety of modules that assess a range of potential past, present and/or future consequences.

In FIG. 1A, a system diagram is illustrated. In the system 135, a user 100 is communicatively coupled to an interface control module unit 200, which in turn is communicatively coupled both av comp 300 and an optimization marginal 600. The v comp module 300, in turn, is communicatively coupled to both the optimization 600 and the decomp module 400. Next, the decomp module 400 is communicatively coupled to a final output module 500, wherein the output module 500 is communicatively coupled to the review module 700. The review module 700, is then communicatively coupled back to the user 100.

The method 125 and the system 135 can be used to model any past, present and/or future interactions between any human-caused environmental impacts (such as population changes, infrastructure changes, traffic patterns, resource consumption and flows, agricultural patterns, water uses, etc.) and any natural environmental impacts (such as groundwater resources, forest type/productivity, weather changes, extreme weather events, climate changes, fire regimes, wetland presence and health, habitat type and health, geology, etc.). The method 125 and the system 135 may also be used to express a plurality of concerns as instructions to the system to portray, evaluate, assess or otherwise analyze the impact of a range of human activities on the natural environment for a variety of time domains.

Additionally, the method 125 and the system 135 can be used to portray, evaluate, assess or otherwise analyze the impacts for a range of naturally occurring events on the built or natural environment for a variety of time domains. It may include past, present and/or future interactions among attributes within the built, human-constructed or altered environment or within the natural environment, or any past, present and/or future external impacts on any space, place or community under consideration.

A User 100 of the method 125 and system 135 may be any individual or group responsible for making decisions affecting any possible future conditions or attributes of an environment. Accordingly, a User 100 of the method 125 and system 135 may be any individual or group responsible for making decisions affecting future conditions or attributes of any of the possible space-time domain for a region and/or legal authority. The responses of the User 100 can be distributed among various submodules within any of the modules to produce a variety of consequence scenarios which can each be separately evaluated, reviewed and/or optimized by the User 100.

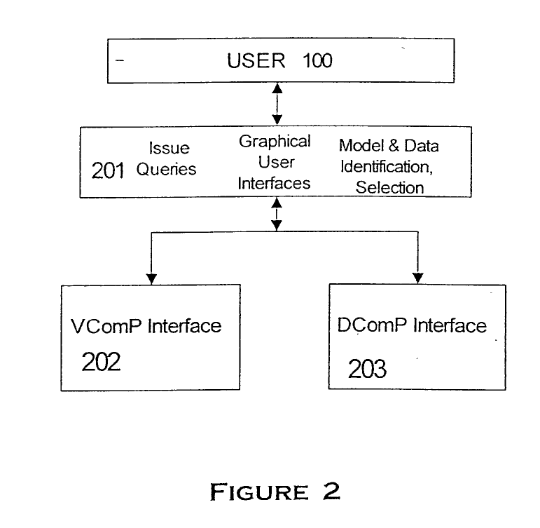

FIGS. 1 and 1A illustrate a method and system 125 and 135, respectively, according to one embodiment of the present invention, which can be implemented through a variety of optional software modules (discussed in further depth with respect to FIGS. 2 through 7) to produce Digital Comprehensive Plan (DComP) representative models for modeling and producing representations of past, present and/or future scenarios. The preferred embodiment allows users to identify, set forth and adopt a sequence of activities guided by one or more generated Digital Comprehensive Plan representative models by which various scenarios can be modeled and represented. This in turn enables the User 100 to model a more desirable and sustainable future for a given space and to identify actions which might accomplish this objective.

In a preferred embodiment, a User 100 initiates the modeling plan by interacting with various modules of the system using an Interface Control Unit or Module 200 through a Graphical User Interface (GUI) 201 (FIGS. 1B, 2, 3, 8, and 10). As used herein, unit or module can be used interchangeably, it being understood that a software module is a specific example of the more general unit. Other examples of units include separate or integrated computer hardware devices, firmware, etc. The GUI 201 serves as an input or control mechanism that enables the User 100 to interact with the system. Via GUI 201, the User 100 can, for example, identify issues, input relevant data, select output media and provide other instructions or inputs to the various modules. In a preferred embodiment, the Interface Control Module (ICM) 200 allows User 100 to have control over any of the processes and data used by the system.

Next, the VComP Module 300 (FIGS. 1, 1A and 1B) may be used to calculate past, present and/or future scenarios for any user-defined space. VComP Module 300 may also be used to define and generate digital models of future scenarios, such as desirable or sustainable future models of communities, regions, watersheds, legal authorities or the like. The digital models from the VComP 300 can in turn be subjected to conversion by the DComP Module 400 (FIGS. 1, 1A and 1B) in order to create usable representative models in various media for User's 100 consideration to be output through a Final Output Module 500 (FIGS. 1, 1A, 7, 8 and 9).

In addition to providing an output mechanism for the present invention, Final Output Module 500 may be used by User 100 to manipulate the DComP 400 representative models to produce new or altered DComP 400 representative models. Using information from the Final Output Module 500, a DComP representative model may also be redirected to the VComP Module 300 and in turn to a Review Module 700 and/or Optimization Module 600 (FIGS. 1, 1A, 1B, 6, 7 and 8), where the Review Module 700 and/or Optimization Module 600 generate other representative models of preferred scenarios.

This embodiment of the invention can also be used to develop particular scenarios for later use by an authoritative body. This can occur by allowing Users 100 to interface with the DComP Module 400 via the ICM 200 thereby controlling the outcome which in turn will be sent to the Final Output Module 500. Such control can be exercised to produce specific VComP digital model representations as a series of DComP representative models for User 100 evaluation and decision-making support for the authoritative body. The output media and format of the DComP representative models in the Final Output Module 500 can be user-determined and can include three-dimensional virtual, immersive technologies, printed material, audio and/or other stimulative mechanisms.

FIG. 1A illustrates one preferred embodiment which enables the various modules to communicate with each other. In particular, FIG. 1A illustrates a system 135 that provides a self teaching model as well as optimization plans.

FIG. 1B illustrates one of many options for a more detailed level of user-directed and/or automated interaction that may occur among various modules and submodules. FIG. 1B is broken into a plurality of optional modules (illustrated and further discussed in FIGS. 2-5) that may be used by the system as a variety of user input capable interface modules or computer resident interactive interfaces.

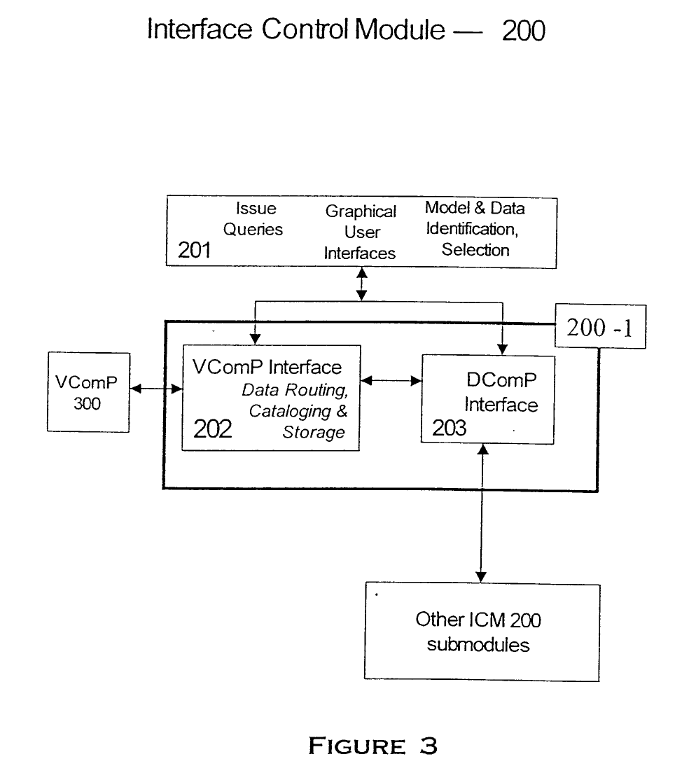

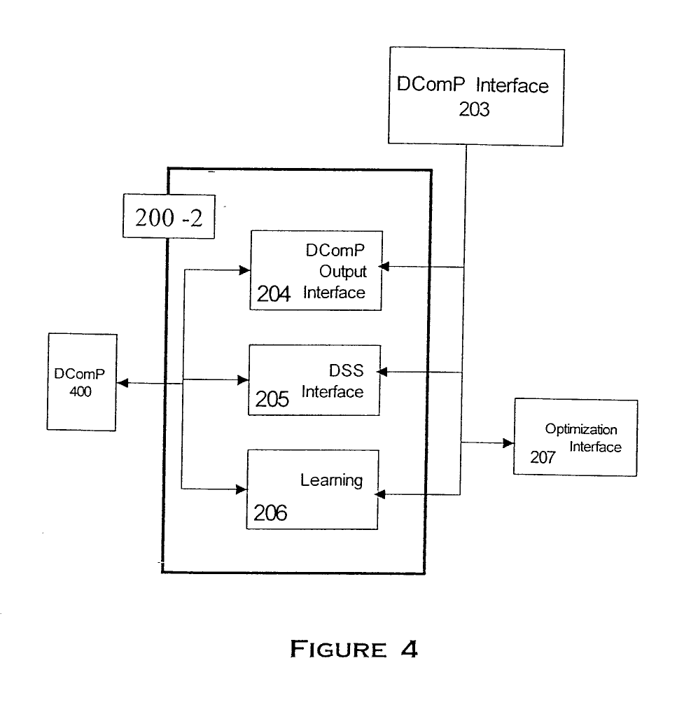

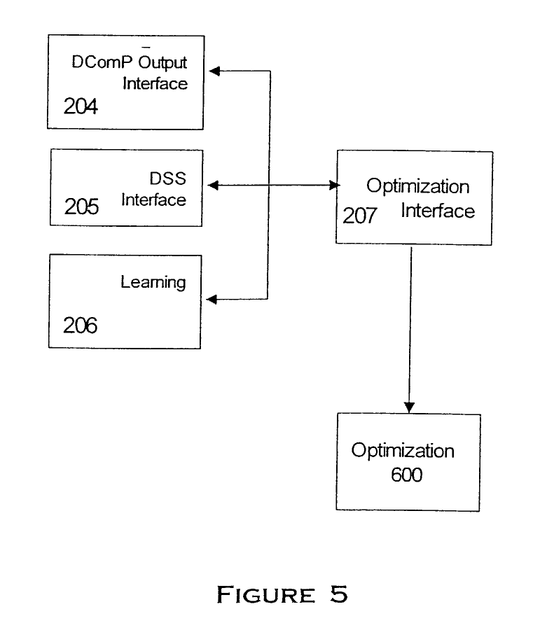

In FIG. 1B, more details as to the interface control unit or module (ICM) 200 are illustrated. Within the interface control unit 200, the user 100 is communicatively coupled to a graphical unit interface 201, which in turn is communicatively coupled to both a VComP interface 202 and a DComP interface 203, where the a VComP interface 202 and the DComP interface 203 are also communicatively coupled to each other. Next, the a VComP interface 203 is coupled to a DComP output interface 204, a DSS interface 205, a learning module 206 and an optimization interface 207, where the DComP output interface 204, a DSS interface 205 and the learning module 206 are communicatively coupled to a DComP module 400. Finally, the optimization interface 207 is communicatively coupled to an optimization module 600. Also, these interfaces are discussed later in detail with the graphical user interface 201 discussed with respect to FIG. 2, the VComP interface 202 and DComP interface 203 discussed with respect to FIG. 3, the DComP output interface 204, the DSS interface 205, and the Learning module 206 discussed with respect to FIG. 4. The optimization interface 207 is discussed with respect to FIG. 5.

FIG. 2, which illustrates interface 201 from FIG. 1B, illustrates an optional preferred embodiment by which an Interface Control Module (ICM) 200 can be automated to allow for the input of various information into system 135. User 100 can use the ICM 200 through a suite of Graphical User Interfaces (GUIs) 201 to input any information.

The User 100 may interact with the ICM 200 via a GUI 201 throughout the entire system's operation including DComP initiation, building, revision, evaluating, monitoring or any other necessary processes. The ICM 200 may also then be used to process, route, store, or control data or otherwise communicate with other modules of the system to accomplish any User 100 instructions or controls to route any relevant data, information or any other source instructions to Virtual Comprehensive Plan Module (VComP) 300. The ICM 200 may also be used to manage factors used by the system, which may include attributes, relationships, requests or other choices provided by the User 100 to cause the system to produce a variety of results. User 100 can also be protected from the mathematical complexities of the VcomP 300 and other modules by entering these choices into the GUIs 201 within the ICM 200.

The ICM 200 can also be used to provide the User 100 a list of models, required data, other information and/or choices that the User 100 desires. The models may be numeric, spatial or 3-Dimensional representations of population growth, spatial changes in surface, subsurface or above ground attributes, natural events such as floods, fires, weather disasters, hydrology, traffic patterns, per-capita attributes, financial, or others. The desired data may be population, population attributes, multiple land use conditions and/or attributes, Geographic Information Systems (GIS) layers, financial and/or any information necessary to fully define the attributes, relationships and range of external impacts for the space under consideration. In this example, the GUIs 201 can be used to query the User 100 for any number of issues including issues of concern, rating of these issues as to priority, selected time frames, attributes, relationship algorithms and other relevant information. The GUIs 201 can also be used to conform the information inputted to a format usable by the VComP Module 300.

Each GUI 201 of the ICM 200 can also be used to identify any submodules resident within the VComP that may be appropriate to any issues identified by the User 100 and can also be used to independently identify any data sets needed to populate the submodules and to instruct the User 100 for any required inputs which in turn are input through the GUIs 201. These inputs may include any attributes that may be needed for the space to be modeled such as past, present and forecasted population information (one-dimensional, numerical information), past, present and forecasted roads and infrastructure (two-dimensional, spatial information), and past, present and forecasted groundwater resources (three-dimensional, volumetric information).

Additionally, the GUIs 201 can be used to provide a plurality of User 100 interfaces for multiple user/model needs and functions to support the User's 100 needs. The GUIs 201 can also be made to be interactive or can be made to manage data and communicate system control information with the VComP 202 and DComP 203 interface modules dependently or independently.

FIG. 3 illustrates interfaces 202 and 203 (collectively ComP interfaces 200-1) from FIG. 1B and shows a preferred embodiment whereby VComP 202 and DComP 203 interface modules can, either automatically or by User 100 direction, interact with the VComP Module 300 or other ICM 200 Modules, such as the DComP interface 203 or the GUIs 201, to effect the management and transfer of data and to effect communication of system control information. Preferably, the VComP Interface Module 202 can be used in conjunction with blocks 201,300,203 or other ICM 200 Modules to sort, route, catalog and/or store the data designated for the VComP Module 300 or manage the internal interchange, integration and synthesis of the data among the submodules (within the VComP Module 300, as discussed below).

The VComP Module 300 can be entirely computer resident and can be used to create and store a variety of factors including mathematical versions of future conditions for the specified space-time domain in response to actual, proposed or historical variables and attributes. The User 100 can input various factors into the VComP Module 300 via the ICM 200 or any other input structure to affect the output of the VComP Module 300. The output of the VComP Module 300 can also be accessed by the user through the DComP Module 400 representative models, which can be used to display the output of the VComP Module 300, or through direct analysis of the VComP digital models for evaluation. The evaluation through the VComP digital models can be accomplished through requests by User 100 through the ICM 200 where the information from the VComP 300 can then be routed for output via the DComP Module 400 and thus evaluated.

The VComP Module 300 can use built environment data such as street, utilities and other infrastructure information with housing type, value and placement on given parcels and other Geographical Information Systems (GIS) information to evaluate past, present and/or future impacts of alternative development scenarios sorted by economic, social and environmental categories. For instance, higher density housing mixed with employment centers may require less transportation infrastructure and a reduction in air pollution, but may allow for an increase in the area's demand for utility services as these may be per-capita based.

The VComP Module 300 can also use natural environment data such as species type, distribution densities, ecosystem baseline and change information and other natural resource data in GIS database to evaluate past, present and/or future impacts on ecosystems of alternative human or natural activities and events sorted by economic, social and environmental categories. For instance, urban encroachment and changing weather regions may individually or collectively have a variety of impacts on the natural environment and natural resources.

In order to run the system, however, there is a minimum amount of input information required for each of the models to generate acceptable outputs from the VComP Module 300. More and/or better quality data can increase the accuracy of the output scenarios, thus providing a higher user-confidence and accuracy in the scenario attributes.

In order to implement the system, a DComP representative model version may be revised to accommodate changing situations or guidelines by a user iterative process and/or a software learning process leading to the identification of a calculated scenario produced by the VComP Module 300 and displayed by the DComP Module 400. Any scenario may then be used, adopted, approved or otherwise made official using the DComP representative models as guides to assist in achieving the calculated scenario.

According to one embodiment of the invention, as illustrated in FIG. 3, the DComP Interface Module 203 can be used in conjunction with blocks 201,202,300 and/or other ICM 200 submodules to access other DComP 400 modules using the DComP Output Interface Module 204 (see FIG. 4). The DComP Interface Module 203 enables the User 100 to request one or more versions of a VComP digital model to be converted to one or more versions of a DComP representative model in selected communications media such as 3 dimensional, animated, 2 dimensional maps, images, immersive, printed, audio and other User 100 communications by the Final Output Module 500.

The DComP Interface Module 203 can also be used to access a Decision Support System (DSS) Interface Module 205 (see FIG. 4) to enable the User 100 to request activation of one or more DSS programs. The use of the DSS programs allow a User 100 to assist in any interactive opinion solicitation and collective decision making activities or to access the DComP Learning Module 206 (see FIG. 4). The DComP Interface Module 205 can also enable the User 100 to collect information by activating the system's learning capabilities or by input by the User 100. The Optimization Interface Module 207 may then in turn utilize the information in directing the Optimizing Module 600 to identify the attributes and relationships necessary to control any of one or more given future attributes, such as quality of life, governmental service level, or water conservation to generate one or more optimized scenarios.

FIG. 4, which illustrates interfaces 204,205 and learning module 206 (collectively the DComP interaction modules 200-2) of FIG. 1B, details a preferred embodiment for the DComP Output Interface 204, the Decision Support System (DSS) Interface Module 205, and the DComP Learning Module 206. While each of the interfaces are illustrated, each of them may be independently used and incorporated into the system 135 without the others.

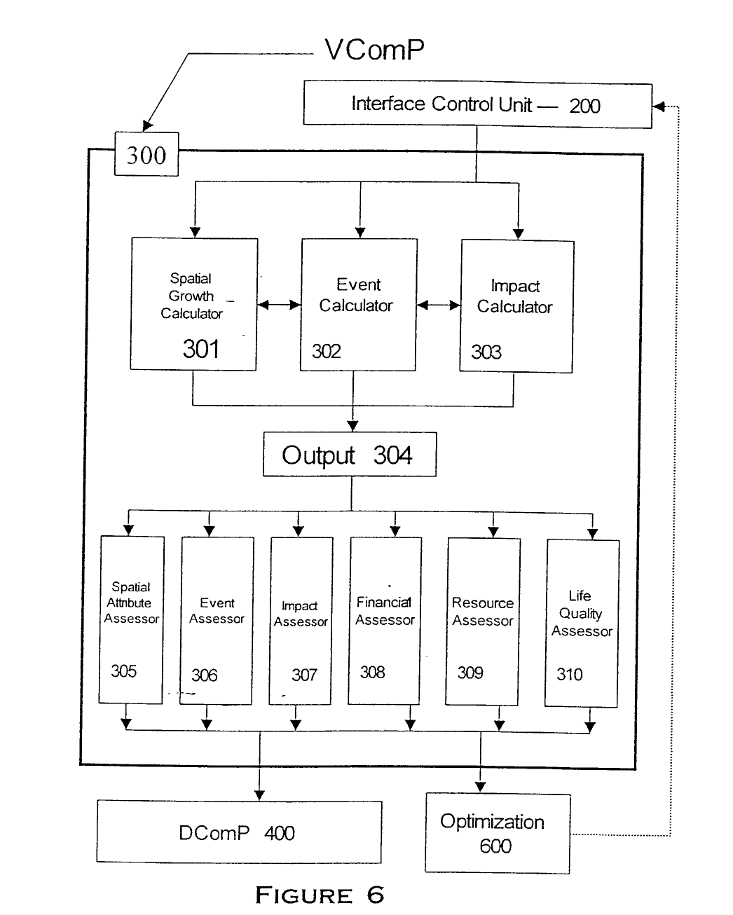

The DComP Output interface 204 may be used to enable the User 100 to request one or more versions of VComP 300 digital models be converted to one or more versions of DComP 400 representative models. The DComP Output Interface 204 may also be used with a DComP Output Format Module 402 (see FIG. 6B) to format DComP representative model versions of a plan into a selected communications media, such as 3 dimensional models, animated simulations, 2 dimensional maps, or various images, immersive, printed, audio and other stimulative communications. These formatted versions can then be output through the First Output Module 500.

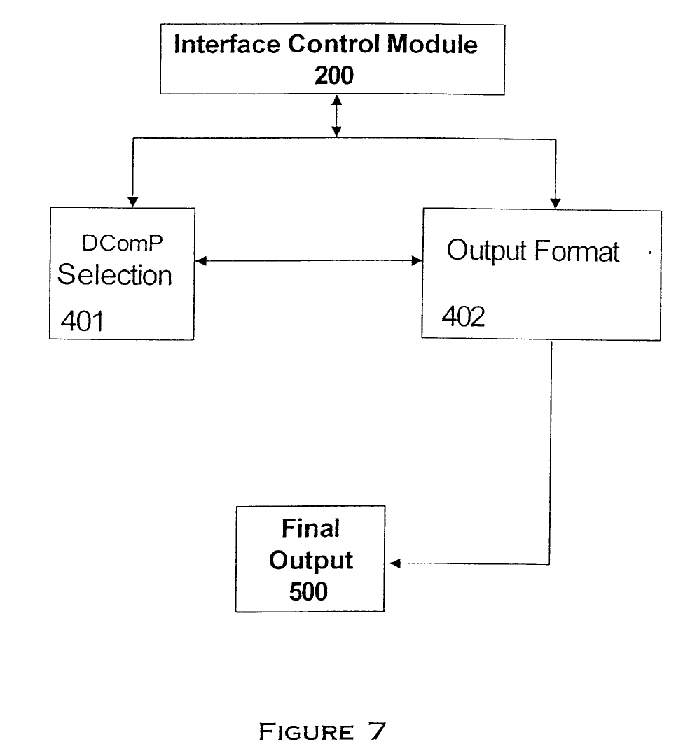

The Decision Support System (DSS) Interface Module 205 may be used independently from the DComP Output Interface Module 204 to enable the User 100 to request that one or more DSS programs within the Decision Support Module 503 (see FIG. 7) be activated for a particular User 100 group. This action can be used to assist with interactive opinion solicitation, collective and other decision making activities, to enable the User 100 to request that one or more manual group processes be utilized in the decision making process and that the DSS software alternatives available within the Decision Support Module 503 be over-ridden or remain unused, or to enable the User 100 to activate any number of alternative decision making systems or processes, or combinations thereof

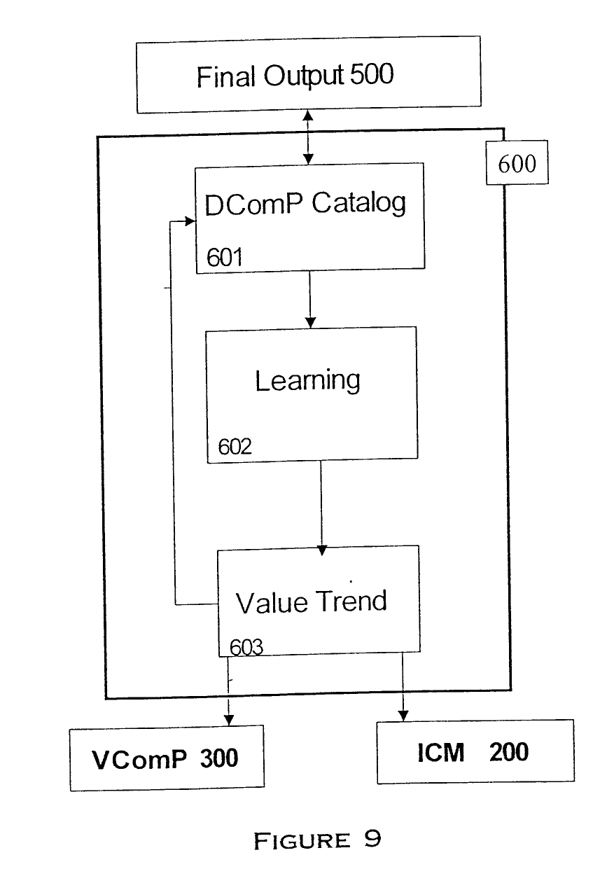

In one embodiment of the invention, the User 100 choices and preferences can also be separately tabulated by a Learning Module 602 (FIG. 9), in addition to or as an alternative to the other modules, in order to inform the system on any past, present and/or future preferences of the User 100. The Learning Module 602 enables the system to automatically generate, in conjunction with or alternatively to the Review Module 700 and/or Optimization Module 600, representative models of alternative scenarios according to User 100 preferences derived from repetitive System 135 usage.

The DComP Learning Module 206 enables the User 100 to activate and use many system wide processes. For example, the Learning Module 600 can be used to activate the system's learning capability, monitor and record decisions made within the Decision Support Module 501 and Adopted DComP Module 504. It can also be used to enable the User 100 to set a plurality of parameters, and/or weights given to any number of User 100 decisions, or to determine and utilize any number of other factors by which the learning takes place. The Learning Module 206 may also be used to access the Optimization Interface Module 207 and enable the User 100 to merge and/or modify the feedback information from the DSS Interface Module 205 which communicates with the Decision Support Module 501 and Adopted DComP Module 504. The Learning Module 206 may also be used to access the Optimization Interface Module 207, which may be instructed by User 100 to utilize any information collected by the Learning Module 206 to automatically generate one or more optimized scenarios.

Further, the Learning Module 206 can also be used to monitor decisions made by User 100 in the evaluation of multiple DComP representative models. It can query the DSS Interface Module 205 for outputs resulting from User 100 processes in the DComP Selection Module 401 of the DComP Module 400. These outputs, in turn, may be stored as data indicative of a plurality and hierarchy of user preferences manifested in the decisions regarding the consideration and/or adoption of a sequence of DComP representative models, or preferred plans over time.

Additionally, the Learning Module 206 may be queried by the user via the GUI 201 to detect trends in shifting values, specific choices or other indicators of preference evidenced by a compilation of the learned data and statistical analysis of user decisions regarding DComP representative models and a plurality of attributes, relationships among attributes and external impacts. The Learning Module 206 may also be directed to generate alternative VComP 300 digital models based on any learned data or statistical analysis from the Learning Module 206 and can also be used to weigh parameters or deliver feedback information to the Optimization Interface Module 207.

FIG. 5 illustrates the Optimization Interface Module 207 of FIG. 1B which can either automatically or by User 100 direction interact with the Optimization Module 600, other DComP Interface Modules 204, 205 and/or the Learning Module 206. The Optimization Interface Module 207 may be used to access selected information, organize and/or otherwise reassemble or process this information, or transfer any or all of this information from the DComP Learning Module 206 to the Optimization Module 600.

Additionally, the Optimization Interface Module 207 may also be used to instruct the Optimization Module 600 to generate one or more new VComP digital model scenarios by optimizing or controlling the values for selected attributes, relationships, time increments, external factors or other variables for a future desired condition. Further, the Optimization Interface Module 207 can enable the User 100 to merge and/or modify the feedback information from the DSS Interface Module 205 and the DComP Learning Module 206 prior to instructing the Optimization Module 600 to generate one or more new VComP digital model scenarios.

FIG. 6 illustrates a preferred embodiment for an automated method of producing a computer-resident VComP Module 300 which can be used to produce digital models of a variety of scenarios. In a preferred embodiment of the present invention, multiple digital model versions of a VComP digital model scenario may exist as a plurality of digital model variations in a computer and may be designated VComPₙ. The multiple versions of the VComP digital models can be used to represent various combinations of attributes, relationships, and/or external factors, which in turn can allow the VComP Module 300 to generate a variety of temporal scenarios and digital models of the scenarios for any given space, 3 dimensional domain or legal authority.

In FIG. 6, the VComP module 300 is illustrated. As illustrated in FIG. 6, the interface control unit or module 200 can be communicatively coupled to a spatial growth calculator 301, an event calculator 302, and/or an impact calculator 303. These calculators, in turn, can be communicatively coupled to an output module 304. This output module 304 can then be communicatively coupled to a spatial attribute assessor 305, an event accessor 306, an impact accessor 307, a financial assessor 308, a resource assessor 309, and/or a life quality assessor 310. These assessors, in turn, can be communicatively coupled to the DComP module 400 and/or an optimization module 600, which in turn can be communicatively coupled back to the interface control unit or module 200.

For the VComP digital models, terrestrial space can be used for bounding the geographical limitations of the VComP digital models (where a terrestrial space is defined in three dimensions by two or more horizontal dimensions, the x and y values, and one or more vertical dimensions, the z value, which may begin below the earth's surface and/or extend above the earth surface). The use of multiple values for any of the axis dimensions at a plurality of points along any axis, permits an irregular space (as opposed to a simple cube) to be evaluated.

The bounded space of the VComP digital models may be assigned various interrelated natural resource and human-built infrastructure attributes by the User 100 through the User's 100 input by setting conditions in response to GUI queries 201 within the ICM 200. There is no limit to the number of past times or future times that can be used to add a fourth dimension to the spatial qualities and that may be introduced into the mathematical model by the User 100 in response to GUI 201 queries within the ICM 200. Thus any number of relational states may be used to represent conditions for the past, present and/or future of a bounded, attributed space to produce an ensemble of four-dimensional scenarios. This can assist in decisions regarding terrestrial issues of space allocation for use by function(s), typically land use, resource use, and/or the interrelationships and impacts of competing uses.

A plurality of consequence scenarios may also be generated by the VComP Module 300 as a result of a variety of impacts from past, present and/or future courses of action by human, natural, external forces or changing attributes. The User 100 can select any space, attribute, relationship, external impact, time and other choices essential to generate a VComP digital model by interaction with the GUI 201, but the User 100 can also be protected from the mathematical complexities of the VComP Module 300 by entering these choices into the GUIs 201 within the ICM 200.

The VComP Module 300 may also serve as a dynamic, computer-resident element underlying various DComP 400 representative model renditions. It can also be used to produce a plurality of digital models depending upon User 100 activities or inputs, any automatic updates to a digital model's data, or by an external input which may be automatically connected or user external upon receipt of an external stimulus such as a revision to a web-based model. A User 100 may also request VComP Module 300 outputs via the GUI 201 to route a request to a DComP output interface 204 in order to shield the User 100 from the complexities of the VComP Module 300.

A VComP may also include a Spatial Growth Calculator (SGC) 301, which is a submodule of the VComP 300 that can be used to generate a variety of attribute and relationship scenarios for a given space for a variety of time increments into the future or into the past for calibration and analysis purposes. The data and information inputs for an SGC 301 may include information descriptive of an entity, a community, and/or a space in the past, present and/or future. This information may be in the form of maps, images or other representations of surface land use or other characteristics input by the User 100, or possibly imported from external sources as directed by the User 100 via the GUI 201. The external sources may be other models from other places and may be manually or automatically accessed and controlled via world-vide web or other linkages.

The proposed and/or hypothetical attributes input into the SGC 301 may be spatially represented in two or three dimensions and may incorporate time information of the past, present and/or future or a combination thereof. If 3-dimensional data is used, such data may contain information on conditions below the earth surface, such as geologic conditions, water resources and conditions, buried infrastructure and other below ground features, or on conditions above the earth surface, such as air quality, building height, meteorological conditions, air traffic spatial allocations and/or other above ground features.

The SGC 301 can also be used to do a variety of applications, such as store, catalog, route and provide metadata for internal/external data storage and retrieval for specifically routing its output to the Output Module 304, or query the User 100 via the GUI 201 for a set of initial conditions, such as actual, proposed, hypothetical or otherwise derived information. The SGC 301 can also be used to set the boundaries of the land for development such as “land bank”, or other space for analysis, set the boundaries of other land reserved for non-development such as “preserved land”, or other space for exclusion from change analysis.

Further, the SGC 301 can also be used to assign conditions, if desired, within the used/unused land areas above by developing applications to conditions other than land use. These conditions may be set or vary with time and can include relationships among land, or other spatial, uses to define the impacts from various courses of action or changes in attributes. For instance, the condition of a high-density development adjacent to a wildlife preserve may, eliminate the value of the preserved land to wildlife and this condition would be accounted for by the SGC 301.

Additionally, the SGC 301 can also be used to define the rules by which land is utilized. For example, if a new single-family residential is placed only within 1 mile of existing residential in an effort to limit sprawl, the system through an SGC 301 can generate a variety of growth scenarios for this attribute over a variety of time periods.

The SGC 301 can be used to incorporate, define and utilize any number of rules and/or methodologies which can be either permissive or exclusive in assigning/excluding specific land for a specific use, such as inflows/outflow of water, and other environmental criteria. Also, the SGC 301 can be used for applications other than land use, such as spatial change conditions like mining operations, etc.

The SGC 301 can also be used to perform a plurality of calculations on the inputted data. The SGC 301 can be used to allocate data sets to appropriate models through User 100 direction via the GUT 201 to construct the desired scenarios. A number of calculations can be performed including the following: the determination of the amount of land per time increment and land use type that must be developed to accommodate a given growth rate, a change in attributes, external impacts or alternative change scenarios represented by a variety of attribute and relationship sets.

For example, with respect to land use, a parcel may be defined as a tax assessor's parcel with a land area of two or more dimensions within a model of an entire system of multiple parcels and ownership of a fixed size or other common designation for a unit of land. The parcel may be designated with attributes and relational characteristics which may vary throughout the particular parcel, but may also include other specific ownership and other attributes. Additionally, with respect to system applications other than land use, a parcel may be defined as a space having multiple values in any or all dimensions and can also have a plurality of other attributes and relational characteristics, which may vary throughout the space defined and the time domain assigned.

The SGC 301 can also be used to perform calculations for past, present and/or future land use utilizing any or a combination of several methodologies which both determine and respond to the spatial relationships among various attributes, relationships, external factors and other input components. All of the growth rules cited above may use any, all or a combination of the following calculation methodologies. Examples of calculation methodologies include random change (where parcels selected at random from the land bank to fulfill the growth needs of the specified area) or competitive change (where parcels within the land bank are each assigned attributes for attractiveness to change or development). Additionally, spatial criteria may be used, or may be set to be overridden by growth rules to assure change for specific areas.

A series of spatial criteria may be utilized with the SGC 301 of the VComP Module 300 to provide a calculation input for a variety of land use options such as proximity away from, or directed to, specific places or areas or to a percentage or numerical value allocation for any area, sub-area or group of parcels within a land bank. The spatial criteria may be set within the method 125 and system 135 to be excluded from further change or development when its population, percentage of development, percentage of water use, level of pollution or other attribute or combination thereof reach a preset percentage or value.

The function of the SGC 301 may also be interactive with the Optimization Module 600 via the Impact Assessor 307. Such interaction would permit the User 100 through the GUI 201 to set or assign preferred limits for selected attributes.

These spatial criteria can be assigned a series of attributes (including variances of specific attributes) to an entity such as an individual, a place or other identifiable factor that is capable of replicating population growth or any other change and the ensuing land uses or other impacts within a selected area or space. Additionally, overlay allocations may be used to integrate selected criteria, which may vary with time to eliminate or promote certain changes, or specific parcels change under any allocation methodologies. These and other calculation methodologies may be executed to produce alternative change or development scenarios.

For applications to spatial situations other than land use a variety of other calculation methodologies may also be chosen, set, proposed or tested. These may be either inclusive or exclusive.

For analysis on applications other than land use, the output of the SGC 301 can be used to render a variety of space-time attributes and conditions. The SGC 301 can also be used to manage the spatial inputs within the VComP Module 300, interact with the User 100 via the GUI 201, or accept the numerical outputs from the Impact Calculator 303 and/or the Event Calculator 302 for specific scenario generation. The SGC 301 can also be used to route selected outputs which may be maps, calculations, other results or any combination thereof to the Output Module 304.

In addition to the SGC 301, a VComP Module 300 may also include an Event Calculator (EC) 302 which can be used to calculate the impacts of a short-term event, such as geoclimatic event, such as a tornado, flood, tsunami, naturally occurring fire, volcano or hurricane, or human-caused events such as fire, terrorist activity, and other short-duration actions. The EC 302 may accept a variety of input data and calculate and simulate the occurrence of a specific event that may be difficult to predict in time, but is fairly certain to occur. The EC 302 allows a User 100 to input any predetermined data or any acquired numerical, spatial and attribute data that can define a specific event, any 3-dimensional movement trajectory or other such information appropriate or definitive of an event into the system 135.

The data can be from an event interface in the GUI 201 or can be from any external source identified in the ICM 200 as long as the input is descriptive of both the entity, community or space in the past, present and/or future and also the event in the past, present and/or future. Various scenario assessments could be conveyed to the Optimization Module 600 (via the Event Assessor 306 and by User 100 instructions to the GUI 20) to perform the calculations necessary to optimize financial investments in the built infrastructure as a function of loss impacts from specified events. This would assist in establishing relationships between fiscal policy and the resilience necessary to accompany sustainability.

Typical events that can be simulated by the EC 302 may include aforementioned geoclimatic events and also disease occurrence and spread, new economic scenarios, other environmental or human-caused occurrences and events and those attributable to a changing global climate. Any event once identified, attributed and constructed may be overlaid on any past, present and/or future land use scenario through the VComP 300 to determine the historic, present or likely future impacts of a given event type over a plurality of spaces and times.

Impacts on the built environment from any event scenario for input in the EC 302 may be produced by building algorithms which combine attributes of an event like flood water levels, wind speed, etc., with selected built attributes of the impacted parcels, such as building type, value, age, etc. The latter can be located in GIS data layers. Similarly, impacts on the natural environment from any event scenario may be produced by building algorithms which combine attributes of an event, such as flood water levels, wind speed, etc., with selected natural attributes of the impacted parcels, such as ecosystems, wildlife populations, habitat type and characteristics, etc. These impacts, then in turn, can be presented to the User 100 through representative models produced by the DComP 400.

An Impact Calculator (IC) 303, which is part of the VComP Module 300 as illustrated in FIG. 6, can be used to generate the impacts of change over a long period of time (contrasted with the Event Calculator 302 which may be utilized for short-term, discreet events). The IC may accept a plurality of numerical data and information inputs via a GUI 201 in the ICM 200. The data information accepted by the IC 303 can be descriptive of an entity, a natural or built environment or combination thereof, a community or space in either the past, present and/or future, a rate of population growth, a category of population growth, a housing mix, a number of people per household, a per-capita water consumption, or any type of generated, aggregated output which can be land area needed by housing or land use demand type, resource consumption rate, or water generation information, etc.

Additionally, the IC 303 may accept an output of the SGC 301 which may define the actual, predicted or proposed attributes of a space for a past, present or future time, actual data descriptive of the present condition, or proposed attributes for a space in a future time. The latter could be used to test a variety of attribute and relationship conditions and evaluate the resilience of that attributes and relationships thereof to a plurality of long-term changes. Various scenario assessments could be conveyed to the Optimization Module 600 (via the Impact Calculator 303 and by User 100 instructions to the GUI 201) to perform the calculations necessary to optimize financial investments in the built infrastructure as function of negative impacts from specified growth scenarios and attributes. This would assist in establishing preferred attribute and relationship scenarios among growth policies, fiscal policy, infrastructure configurations and the long-term goals of the User 100.

For an IC 303 the land area needed, for instance, may be calculated (then allocated through the SGC 301) using inputted information for population rates of growth by housing type (such as single family, multi-family, rural, etc). and assigning a unit of land area to each unit of growth type to obtain the land area required for each category of land use over a long period of time. The allocation of land by land use type can be thus used to determine the total land required to support a given, proposed, historic or hypothetical growth scenario. The output of the IC 303 data and information can be stored in an Output Module 304 as long term impact data assigned to a specific scenario to support the generation of a specific VComP, in order to manage the numeric single dimensional inputs within the VComP 300, although this numeric data may be applicable to two or three dimensional spatial configurations over a plurality of time.

In addition to the SGC 301, the EC 302 and the IC 303, a VComP 300 may also include an Output Module (OM) 304, which can be used to receive data from these three modules. The data received can be assigned to a specific scenario to support the generation of a specific VComP digital model or VComPₙ and can include metadata regarding these data sets and/or route them to other model elements for future access. The data can also provide data inputs for assessors 305 through 308 or can accept direction from the User 100 via the GUI 201 regarding data management, alternative data storage locations, integration, or other necessary functions.

After the VComP Module 300 subjects the inputted information to the SGC 301, the EC 302 and/or IC 303, the calculated outputs from these modules are received by the Output Module (O) 304. The information from the OM 304 can then be subjected to one or more assessors 305 through 310 for integrated assessment calculations.

A Spatial Attribute Assessor (SAA) 305 can be used with or without the other modules of the VComP 300 to accept a plurality of inputs regarding spatial attributes, such as water availability, land use, transportation, infrastructure or resource location by type. The inputs can be routed by the OM 304 and can originate with either the Spatial Growth Calculator (SGC) Module 301 or the User 100 via the GUI 201. The SAA 305 can be used to integrate these inputs and synthesize individual spatial changes into integrated assessments of spatial changes for a variety of scenarios, either human-caused or naturally-occuring. The SAA 305 can also be used to assist the User 100 in evaluating various spatial impacts and the results of a plurality of generated scenarios

An Event Assessor (EA) 306 can be used with or without the other modules of the VComP 300 to accept a plurality of inputs routed by the Output Module 304 and originating with either the Event Calculator (EC) Module 302 or the User 100 via the GUI 201. The EA 306 can be used to integrate these inputs and synthesize them into scenarios of natural event impacts on the built or natural environment of a simulated model. Examples of the use of the EA 306 include but are not limited to evaluating event scenarios to identify attributes and relationships which can alter the negative or positive impacts on a space or legal authority, or arranging these event scenarios by economic cost/benefit or other analytical methodology into a plurality of categories.

The EA 306 can be used with or without the other modules of the VComP 300 to communicate with the EC 302 to obtain event scenarios which may be superimposed on any future growth scenario or DComP representative model. The EA 306 can then be used to determine potential impacts from specific natural events to provide outputs to the DComP Module 400 to portray a plurality of event impact scenarios as calculated by the EC 302 or to provide output to the OM 600 to portray a plurality of event impact scenarios as calculated by the EC 302.

An Impact Assessor (IA) 307 of the VComP Module 300 can also be used with or without the other modules of the VComP 300. From the Outputs 304, the IA 307 can be used to determine the long-term effects caused by a plurality of impacts resulting from either human-caused or naturally-occurring activity, including but not limited to development, growth, redevelopment, additions or deletions from the infrastructure inventory or other changes.

Typically, impacts that can be modeled by the system include but are not limited to changes in groundwater resources due to a change in water use due to changes in the population, changes in agricultural use, and/or any other demands on the water supply as a function of changes over time in the attributes and relationships for a given space, changes in transportation flows due to changes in the population, the number of vehicles in service, the land use patterns, the alternative transportation infrastructure, and/or any other changes and demands on a particular infrastructure as a function of changes over time for a given space.

Other impacts can include changes in the level or quality of government or utility provided services (due to changes in the population, the type of services required, or the land use patterns, and/or any other demands on governmental or public service infrastructure), changes in air quality (due to changes in the population, new technologies for pollution reduction, alternative transportation infrastructure, the industrial economy of the region and/or any other changes which may affect air quality) can also be included. These examples do not preclude the use of the IA 307 for the assessment of impacts resulting from a plurality of additional changes in attributes, relationships and external impacts in the built and/or natural environment, either past, present and/or future.

The LA 307 can also determine, in addition to other impacts, the fiscal impacts, either past, present and/or future from changes in attributes and relationships in the built environment which may be based on capital costs, replacement costs, societal and environmental costs, other costs and/or any combination of these cost sources. The LA 307 can include other methods of assessing the full, long-term costs of past, present, proposed or future changes in the built or natural environment attributes, relationships or external impacts.

Further, the IA 307 may provide output to the DComP 400 or the OM 600. When the output of the IA 307 is directed to the OM 600, the IA 307 can have interaction with the ICM 200 enabling the OM 600 to solve certain impact problems or issues using algorithms and equations by interacting with those from the LQA 310 for certain combinations of attributes of the built environment which may produce or cause certain impacts. This permits the User 100 to instruct the OM 600 via the GUI 201 to manipulate changes in attributes or relationships for a space to optimize for preferred or selected values of other attributes such as life quality, water consumption, transportation, wildlife, etc.

The IA 307 may also be configured with the OM 600 to limit or contain growth or change when certain thresholds are reached for selected attributes or relationships. Users 100 may thus test or set certain limits beyond which they suspect growth or additional change along a given trajectory may become undesirable.

In addition to the IA 307, a Financial Assessor 308 of the VComP Module 300 can be used with or without other modules to extract information from any of the Calculator modules 301 through 303 via User 100 direction and obtained from the Output module 304. This data can be converted into cost data, for instance, miles of specified types of roads to be built, watermains to be constructed, commercial services, public safety, etc.

The Financial Assessor 308 may also be used to extract loss information from short-term events defined by the Event Calculator 302. This information may be obtained via the Output module 304 by overlaying event attributes such as the intensity, duration and movement trajectory based upon the short term events on parcel valuation data layers which may represent either natural or built environment values or a combination of both.

The Financial Assessor 308 may also be used to extract cost information from long-term events, courses of action or change defined by the Impact Calculator 303. This information may be obtained via the Output module 304 and summing the costs over time of certain services or infrastructure provided, certain resources used or provided, certain wastes generated, and/or other impacts which may be quantified economically. The cost data, either by category or summed, can be used to assist in current decision making which may produce certain spatial attributes and/or relationships. This economic information can assist in making potentially costly decisions.

One assessor, a Resource Assessor (RA) 309, can be used with or without the other assessors to accept data from the Output Module 304 or from the User 100 via the GUI 201. This data can include but is not limited to any information regarding resource consumption by type, population unit, land use attributes, time increments, or other attributes for the study area. The RA 305 can also accept data for any relationship between resource flows and economic well-being for a population unit (to generate information regarding a region's instantaneous or long term economic competitiveness or sustain ability) and/or any User 100 choices made in the GUI 201.

Further, the RA 309 may be used to project past, present and/or future rate(s) of consumption/waste as a function of other actual, or assumed, attributes for the selected space-time domain, or to produce an aggregated output as an indicator of the total demands for natural resources or pollutants of a chosen population unit for a given time period produced by a functional element, community, region or spatial activity.

The RA 309 can also be used to produce calculations for present and projected indicators of economic competitiveness, resource consumption and waste generation or may be used to integrate, aggregate or synthesize any or all of the above information to produce a plurality of indicators of a study area's sustainability. Further, the RA 309 may be used to analyze consumption patterns on a continuum from the individual to the global scale and vary certain attributes to obtain various sets of common metrics affording relative comparisons of consumption patterns.

In addition to the RA 309, a Life Quality Assessor (LQA) 310 of the VComP Module 300 can be used with or without the other modules to accept data regarding the quality of life of a simulated model. The data can include but are not limited to a plurality of indicators regarding life quality, place quality, and general public satisfaction with the attributes of a given space (hereafter indicators) or can be used with time increments past, present and/or future associated with these indicators from the OM 304 or the User 100 via the GUI 201. Other attributes of the space which may be associated with the indicators and time increments may also be assessed to determine, calculate or otherwise manipulate a plurality of relationships between indicators and the attributes.

Further, the LQA 310 can be used to calculate past, present and/or future values for indicators or to provide for a plurality of indicators by varying the attributes. The LQA 310 may also be used to develop algorithms and equations which define indicator/attribute relationships by interfacing with the User 100 via the GUI 201 or to provide output to the OM 600 through the FO 500. The output to the OM 600, in turn, enables the OM 600 to solve the algorithms and equations for certain combinations of attributes at various times to produce and/or maximize single or multiple indicators. The output to the OM 600 may also be used to provide output to the DComP Module 400 for calculated indicators as a function of calculated or User 100 input attributes, either past, present and/or future. The output from the LQA 310 may also be separately matched to VComP versions and may be input into the OM 600 and/or the LM 602 if so directed by the User 100.

Finally the LQA 310 may generate a single output value, for instance on a scale of one to ten, representing the aggregation of a number of attributes or relationship for a given space and time on the life quality of a model. This single output value may be input to the Visualization Module 301 to alter the output of the VM 501 to reflect certain levels of quality of life or well-being.

Each of the outputs of the SAA 305, EA 306, IA 307, EA 308, RA 309, and the LGA 310 may be assigned a format compatible with the other outputs of the assessor to enable the OM 600 to interact equally with each assessor module. The OM 600 can then be used to determine which attributes and relationships may be varied from among the various assessment modules to optimize certain indicators, attributes, relationships, external impacts or other variables depending upon the desires of the User 100.

In order to output a representative model from the VComP Module 300 to the User 100, the system generally uses a DComP Module 400 as illustrated in FIG. 7 but any output conversion can be used to convert the digital models of the VComP Module 300 to representative models for output. In FIG. 7, a preferred embodiment of the DComP Module 400 for accessing and/or producing a plurality of versions of VComP digital models for input to the Output Module 500 is illustrated. Preferably, the DComP 400 is dependent on the output of the VComP 300 received via the ICM 200 and instructions from the User 100 via the GUI 201.

The DComP Module 400 can accomplish its output functions using two modules. The first module, a DComP Selection Module (DS) 401, is interactive with the ICM 200 for User 100 instructions via the GUI 201 so that User 100 may select a version of a given VComP digital model from VComPₙ, for output production. Through the ICM 200, the User 100 can repeatedly select any or all of the VComP digital models produced for output and routing to other locations, such as output devices to produce and/or route any number of DComP representative models. User 100 can also select VComP digital models for communication of the VComP digital model which may be visual be produced by any number of immersive technologies. The DS 401 can also be used to take any version of a DComP representative model and reduce it to a printed format with assigned text for transfer with the other types of information to the Output Format (OF) Module 402.

The second module, the Output Format (OF) Module 402, can be used to interact with User 100 via the GUI 201 to query for and identify any formats of a desired output to support a plurality of output devices, mechanisms and processes as defined in the Final Output (FO) Module 500. The OF 402 can then be used to format the output from the ICM 200 and the DS 401 for output to the FO 500.

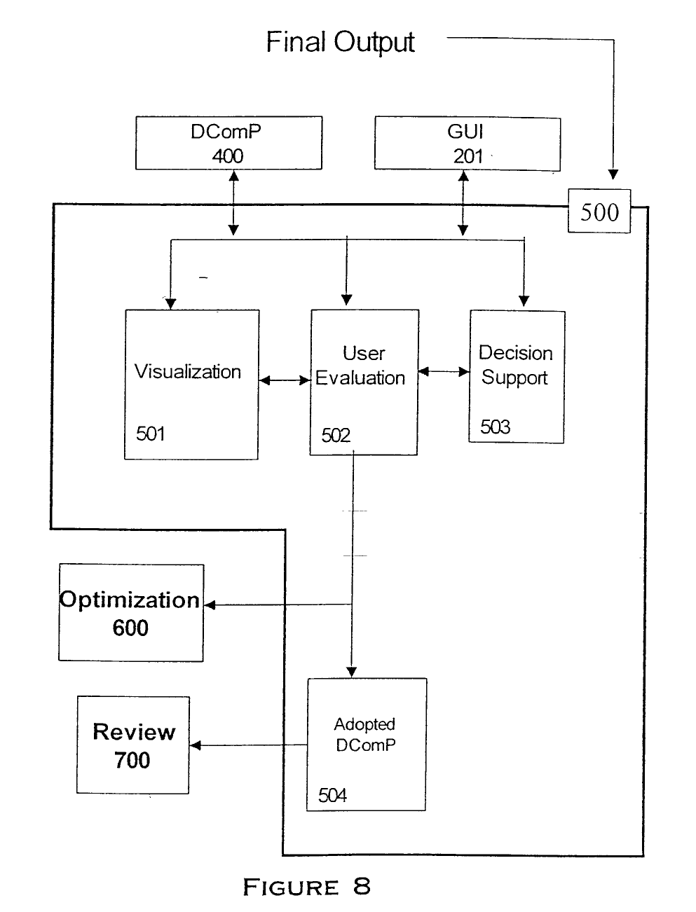

FIG. 8 illustrates a preferred embodiment of the Final Output (FO) 500 Module for an automated method of producing single or multiple DComP representative outputs from system-resident VComP digital model versions for User 100 evaluation and decision processes is illustrated.

The FO 500 can be used under User 100 direction via the GUI 201 to produce a single or ensemble of DComP representative models for output to the FO 500. The output from the FO 500 may, in turn, then be in any format, such as digital, printed, visual, or a combination thereof, or any other media of communication. The selection of media and other visualization criteria can be automatically controlled by the system or can be user-controlled via the GUI 201 to display the representative models individually, simultaneously, overlaid, fused, viewed with selected features extracted, or otherwise manipulated by the system or the User 100 to aid in any decision process.

The output from the system can be presented through the FO 500 as a plurality of printed, visual and other forms of the representative models for presentation, review, and evaluation. The output can also be used to represent integral parts of a preferred future scenario or to provide Decision Support System (DSS) assistance to a User 100 to assist with any review and selection process of one or more representative models.

In FIG. 8, the process of formatting a final output is illustrated. As illustrated in FIG. 8, a DComP Module 400 and/or a Graphic User Interface Module 201 can be communicatively coupled to a Visualization Module 501, a User Evaluation Module 502, and/or a Decision Support Module 503, each of which can also communicatively coupled to each other. Next, the User Evaluation Module 502 can be communicatively coupled to an Optimization Module 600 as well as a Review Module 700 through an adopted DComP module 504.

A Visualization Module (VM) 501, which makes up part of the FO 500, can be used to provide single or multiple displays for User 100 of any or all of the DComP representative models. The displays provided by the VM 501 can include but are not limited to maps in GIS compatible or other formats, three dimensional models using any number of internal or commercially available software, overlays, which may be maps applied to any spatial or three dimensional representation to portray, extract or highlight any variety of existing, historical and/or proposed attributes.

The displays of the VM 501 may be of any timeframe as appropriate to illustrate a scenario or outcome or any number of immersive, virtual reality, holographic, or other communication media which effectively convey complex information to a lay or expert audience. These displays can basically be used to aid in visualizing any range of attributes, relationships, external factors and time periods defining a space responding to a plurality of decisions which the User 100 may be considering.

Additionally, the VM 501 may accept from the LQA 310 outputs representing, for instance on a scale of one to ten, the aggregation of a number of attributes or relationships for a given space and time. This information may be input to the Visualization Module 501 to automatically alter the output of the VM 501 to reflect certain levels of quality of life, well-being or other factors.

A User Evaluation Module (UEM) 502 of the FO 500 may be used to provide interfaces with User 100, the Visualization Module 501, the Decision Support Module 503, the Optimization Module 600 and the Adopted DComP Module 504. The UEM 502 may be interactive with the output from the Visualization Module 501 by allowing the UEM 502 to alter or DComP representative models through a number of communication media selected by the user 100 via the GUI 201 to sort, store and otherwise manage data regarding User 100 choices regarding a plurality of DComPs.

The UEM 502 may also be used to transfer a preferred DComP representative model, which has been identified by the Decision Support Module 503, to the Adopted DComP Module 504 and the Optimization Module 600 upon User 100 instructions via the GUI 201. The UEM 502 may also be used to update DComP representative model versions through the addition of updating additional User 100 data. This data may include alterations that User 100 may want to make to any DComP representative model indicating a preference for certain combinations of attributes, relationships, and/or times. If no preferable scenarios are presented, User 100 may initiate construction of DComP models by entering new conditions, attributes, relationships, external factors, time periods or other relevant data through the GUI 201. User 100 decisions regarding the DComP representative model versions can be sent to the OM 600 for storage and/or manipulation by the LM 602 and can be used to enable the system's self-teaching features.

A Decision Support Module (DSN) 503 of the FO 500 may be used in conjunction with or independently from the VM 501 and the UEM 502 to guide Users 100 in the selection of a DComP representative model or other future scenario plan. The DSM 503 may be used to access a wide variety of decision support software or other types of decision support interactions including what may be contained within the DSM 503, or- software produced and/or provided by others and accessed via the Web or recorded devices.

The DSM 503 may contain a number of decision process methodologies for jurisdictional bodies or the general public. The methodologies can include but are not limited to various instructions and/or recommendations by social scientists, decision process experts and/or others as needed by the User's 100 needs, issues, and customs. The decision methodologies for inclusive, decision-producing public process, and/or various methodologies used by the jurisdiction or legal authority may also include any custom instructions of the User 100 and/or other result oriented processes for obtaining public/private decisions by consensus, vote or other incremental process.

When a preferred DComP representative model is identified and selected through the UEM 502 possibly with the aid of the DSM 503 and the VM 501, the selected DComP representative model may be routed to an Adopted DComP Module 504. Each of modules 501, 502 and 503 may be intensely interactive and used simultaneously under the control of the User 100 via the GUI 201 in order to select an Adopted DComP 504 for Final Output 500.

An Adopted DComP Module (AD) 504 of the FO 500 can be used to identify and record the appropriate public process by which a selected DComP representative model is made the official and guiding plan for any space, region, and/or other legal authority. This information, which may be provided by the UEM 502, may include a public vote in a regular election, a special referendum vote, a separate, confirming or final vote of an elected body, or a decision by staff persons and/or decisions by all or some of the members, employees or those otherwise associated with a jurisdiction, corporation or other legal authority.

Any or all of the above may include additional processes essential to finalize the results of modules 501, 502 and 503 as deemed necessary to formally, officially adopt a DComP representative model version as the single Comprehensive Plan which may be used to guide and/or govern the activities of an authoritative entity to produce a commonly desired future for a space, region, community or other defined domain. The adopted DComP representative model 504 may be published and/or represented by a plurality of media and/or routed to the Review Module 700 either immediately or at any later time for review and modification and can engage any or all of the system modules.

FIG. 9 illustrates a preferred embodiment for an Optimization Module (OM) 600 which has an automated method of producing VComP digital models based on User 100 initial, continued and iterative interaction, decision events, and/or processes with a plurality of DComP representative models in the Output Module 500. As illustrated in FIG. 9, within the Optimization Module 600, a DComP Catalog module 601 can be communicatively coupled to both the Final Output Module 500 and a Learning Module 602. The Learning Module 602, in turn, can be communicatively coupled to a Value Trend Module 603. A Value Trend Module 603 can then be communicatively coupled to the VComP Module 300 and/or the ICM 200, as well as can be communicatively coupled back to the DComP Catalog Module 601.

The OM 600 of the system, through the gathering of choices of User 100 in evaluating a variety of DComP representative models, can be used to automatically designate re-input choices based on a statistical analysis of User's 100 previous choices when the statistical analysis is gathered by the DComP Catalog Module 601, the Learning Module 602 and the Value Trend Module 603, as illustrated in FIG. 9 and discussed further below. The OM 600 through the gathered statistics can then instruct the VComP Module 300 to generate a future scenario that can meet certain criteria of the past User 100 instructions.

The OM 600 of the system can also be used to integrate User 100 decision, process, scenario preference and other information from the Final Output Module 500. The OM 600 can then be instructed via the GUIs 201 to construct new DComP representative models, which better respond to user-chosen values for future criteria, such as quality of life, water availability, economic values, transportation congestion, etc. and can also be set to automatically rerun, or recompute VComP digital models until predetermined, preferred or necessary conditions are represented by one or more of the system generated DComP representative models.

Additionally, the OM 600 may be instructed by User 100 to calculate and identify a set of attributes and relationships for a space and time which are most likely to optimize one or more future attributes or relationships for the chosen space and time.

Further, the OM 600 may be instructed by User 100 to calculate when a given threshold for one or more attributes or relationships may be reached and the likely future time when this may occur. At User 100 instruction, the attainment of this condition or threshold may be fed back into the SGC 301 to halt additional growth calculations. Alternatively, the attainment of this preset condition may instruct the SGC 301 to place the growth elsewhere or otherwise continue the growth calculations but with modified outcomes identified to the User 100.

The DComP Catalog Module (DC) 601 of the OM 600 may be used to sort and store a plurality of DComP representative models that can be obtained from the UEM 502. The DC 601 may be used to rank, sort, and/or store these DComP representative models in a particular order according to User 100 preference, thus creating an ordered catalog of DComP representative models.

The Learning Module of the OM 600 (LM) 602 may be used with the DC 601 to sort any attribute, relationship, external factor and/or time data associated with any DComP representative models stored in the DC 601. The LM 602 may also, under User 100 instruction via the GUI 201, apply a plurality of statistical analysis or other tools to determine which characteristics of the attribute, relationship, external factor and time data are most valued by the User 100. Further, the LM 602 may be used to store, compile and/or access a data library of statistical and/or other analysis tools for application to the selected DComP representative models or to recatalog, save or otherwise create a new library of attributes, relationships, external factors and time domains for DComP representative models in accordance with a User's 100 choices.

Additionally, the LM 602 may receive data by remotely sensing and acquiring, data regarding past, current or impending events. This information may be used to inform the LM 602 of activities representative of prior decisions and/or inform a Value Trend 603 module of new decision directions.

The Value Trend Module (VT) 603 of the OM 600 can be used in conjunction with the DC 601 and the LM 602 to further assess a plan using a plurality of statistical tools, including a new library of various data compilations stored in the LM 602. The VT 603 may also interact with User 100 via the GUI 201 to receive a variety of instructions from the User 100 regarding the statistical tools and alternative sorting systems to be utilized to obtain and rank user preferences and values or communicate information regarding recorded trends to User 100.

Further, the VT 603 may be used to identify and record User's 100 set threshold values for given attributes, relationships, external factors or time domains, and may be used to automatically transfer any set of attributes, relationships, external factors and/or time data to the VComP Module 300, which in turn may be used to generate a VComP scenario digital model observing requested thresholds. The VT 603 may also be interactive with and may also support the system's learning functionality by communication with external sources, models and/or web-based information and public opinion and other surveys and may provide feedback of data to or from the DC 601.

Thus, if User 100 preset threshold for one or more values is violated, these violations may be recorded and processed and/or combined with repetitive decision information to aid in determining User 100 value trends either past, present and/or future. This process may be used to optimize a DComP representative model for a particular value or combinations of values. For example, optimizing or controlling the generation of alternative DComP representative models to maximize life quality can be used to produce a particular DComP representative model version having as a primary attribute a User 100 preset minimum or threshold value for life quality as derived from the Life Quality Assessor (LQA) 310. This capability may be used to produce a set of decisions or courses of action necessary to both obtain and sustain a certain value for the controlled variable threshold.

The VT 603 may also be used to automatically change a VComP digital model to keep it aligned with user values by observation of thresholds or to provide successive iterations to obtain a different scenario result envelope having different thresholds. Alternately, the VT 603 can be used to control or optimize a range of desired future scenarios in the produced DComP representative models, and/or specify a range of decisions, actions, policies or other activities to achieve a threshold of certain future scenarios.

Using the system, the OM 600 can be automatically or a User 100 directed via the GUI 201 to transfer data to the VComP Module 300. This data transfer can be used to provide a mechanism by which other DComP representative models may be produced for User 100 evaluation and review. For land use and resource applications, the OM 600 can be used to perform numerous and repeated evaluations of the long-term consequences of a variety of economic, education, growth policies, zoning and zoning changes and other factors with specific implementation mechanisms, such as building codes, financial mechanisms, or the assignment of land for development.

Repeated use of the system can be implemented to update the database using records created and stored in the OM 600 upon repeated use with the preferences inputted and can permit the eventual automatic filtering of decisions to eliminate those that might have a negative impact on an assessment indicator. The repeated and iterative use of the OM 600 may be used to determine a range of attributes, relationships, external factors and time domains that produce a preferred future for a specific legal authority and the policies/laws/building codes and regulations most likely to achieve this objective.

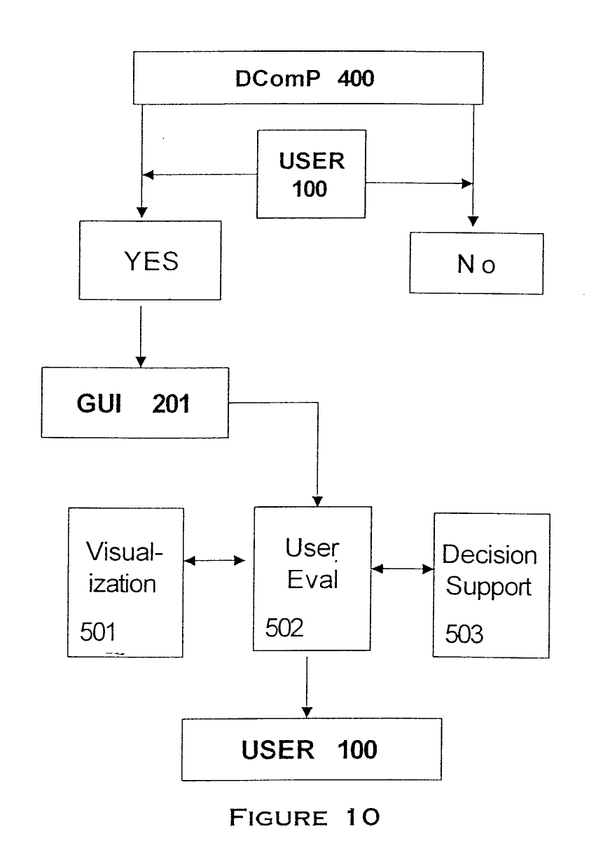

An additional module that may be included in the system is a Review Module (RM) 700. FIG. 10 illustrates a preferred embodiment of the RM 700 which can be used in combination with User 100 interaction, with or without software assistance, to review and/or revise an adopted DComP representative model. In FIG. 10, the User 100 can decide whether a review process is necessary. If so, the desire for a review can be communicated through the GUI to Visualization Module 501, a User Evaluation Module 502 and/or a Decision Support Module 503 each of which can be communicatively coupled to one another. The Visualization Module 501, the User Evaluation Module 502 and/or the Decision Support Module 503, can then be communicatively coupled back to the user 100 for review.

The Review Module 700 can be used by the User 100 to review the information from the Final Output 500 as a review and/or serve as a feedback mechanism. The RM 700 may be used to test proposed changes in attributes of the model, to reflect actual changes in attributes, or to revise the model. The RM 700 can also be made to be User 100 interactive or automated, in that the user of the RM 700 does not need to mandate a revision to the DComP representative model in order to activate the RM 700, as the RM 700 can be automatically activated when existing Plan is deemed satisfactory or unsatisfactory upon review with or without User 100.

The RM 700 illustrates a method whereby the User 100 may at any given time evaluate an adopted DComP representative model and determine whether a review or revision may be desired. If review or revision is desired, the User 100 can be redirected via the GUI 201 to the User Evaluation 502 of the Final Output Module 500 where appropriate tools for conducting a review process and issuing a new DComP representative model version may be resident and similar to the tools/process for generating the initial or previous DComP representative model. If a review or revision is not desired then no further action is necessary.

Any DComP representative model, whether adopted or not, may be revised by the input of new conditions via the GUIs 201 Module of the ICM 200, thus initiating a de-facto Review process.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method of providing or updating a digital comprehensive plan for past, present and/or future community development or planning that is self-contained and capable of direct updating, comprising:
inputting data into an interface control module;
processing the data using the interface control module;
developing digital models of at least one scenario based upon the processed data; and
producing representative models of the digital models.

2. The method as claimed in claim 1, further comprising:
comparing the representative models;
determining a desired model from among the representative models; and
adopting the desired model as the digital comprehensive plan.

3. The method as claimed in claim 2, wherein the determining of the desired model comprises:
reviewing the representative models;
inputting factors for determining preferences to be applied to the community development or plan;
comparing the representative models to the preferences; and
selecting one of the representative models.

4. The method as claimed in claim 2, wherein inputting data into the interface control module comprises:
prompting user input through a graphical user interface; and
recognizing and storing the user input, wherein the processing of the data comprises:
recognizing attributes of the user input;
providing information for developing the digital models using the attributes.

5. The method as claimed in claim 3, further comprising:
recognizing relationships among attributes and using these relationships to provide information for developing the digital models; and/or
recognizing a plurality of external factors and using these factors to provide information for developing the digital models.

6. The method as claimed in claim 4, wherein any user interaction with the method of providing or updating a digital comprehensive plan is through the interface control module through one or more graphical user interfaces.

7. The method as claimed in claim 2, wherein developing each of the digital models comprises:
routing processed data from the interface control module to a virtual comprehensive plan module;
calculating a scenario based upon the routed processed data using the virtual comprehensive plan module; and
developing a digital model of a virtual comprehensive plan by assessing the calculations of the scenario.

8. The method as claimed in claim 7, wherein the calculation of the scenario comprises:
using the routed processed data to determine any attributes, relationships, external factors or a combination thereof that are represented in the scenario; and
calculating any spatial attribute, event attribute, or impact attribute or a combination thereof for the scenario.

9. The method as claimed in claim 7, wherein the development of the digital model of the virtual comprehensive plan comprises:
assessing any spatial attribute, event impact, financial impact, resource impact or life quality impacts, events or a combination thereof on the calculated scenario; and
optimizing any indicators, attributes, relationships, external factors, or a combination thereof to create the digital model of the virtual comprehensive plan of the scenario.

10. The method as claimed in claim 9, further comprising limiting or modifying growth scenarios or change to reflect model-generated or manually input attribute or relationship thresholds.

11. The method as claimed in claim 9, further comprising:
gathering statistical information on prior decisions and activities;
altering the model scenarios to reflect statistical preferences and/or value shifts; and
outputting the digital model of the virtual comprehensive plan based upon these alterations and optimizations.

12. The method as claimed in claim 2, wherein the production of representative models comprises:
inputting the digital models of one or more scenarios into a digital comprehensive plan module;
receiving instructions from the interface control module for selection information, routing information, format information, or a combination thereof for the digital models;
using the received instructions to produce representative models of the digital models; and
outputting the representative models for comparison.

13. The method as claimed in claim 12, wherein receiving instructions further comprises receiving instructions to alter the production of the representative models to automatically reflect values of quality of life or well-being.

14. The method as claimed in claim 12, wherein using the received instructions comprises:
selecting a particular digital model for reproduction of the digital model into a selected media;
routing a particular digital model; and/or
formatting a particular digital model for visual reproduction into a selected media.

15. The method as claimed in claim 12, wherein the outputting of the representative models comprises:
querying for format information through the interface control module;
identifying the format information;
formatting the representative models based upon the format information so the models are capable of being compared; and
outputting the formatted representative models for comparison.

16. The method as claimed in claim 2, wherein the comparing of the representative models comprises:
displaying the representative models visually, audibly or using any appropriate sensory stimuli apparatus to convey to the information of the representative models; and
evaluating the displayed representative models.

17. The method as claimed in claim 16, wherein the displaying of the representative models comprises:
displaying the representative models in a format capable of allowing visualization of any range of attributes, relationships, external factors and/or time periods using a visualization module.

18. The method as claimed in claim 16, wherein the evaluating of the models comprises:
providing one or more interfaces for selection by a user;
sorting, storing and/or otherwise managing the selections of the user;
altering, presenting or reconstructing the models based upon the selections of the user to update the models; and
comparing any range of attributes, relationships, external factors and/or time periods for each of the models.

19. The method as claimed in claim 2, wherein the determining of a desired model comprises:
guiding a selection of a desired model through a decision support module, decision process methodologies or other result oriented processes; and
selecting a desired model based upon the guidance of the decision support module, decision process methodologies or other result oriented processes.

20. The method as claimed in claim 2, wherein determining the desired model further comprises:
re-inputting the representative models for further data processing using the interface control module; and
optimizing the re-inputted models to construct new models based upon the further data processing and to rank, sort and/or store these new models according to any further instructions from the interface control module and any data compilations based upon any identifiable trends of previous inputs into the interface control module.

21. The method as claimed in claim 20, further comprising inputting information representing a cessation of growth and/or change when certain thresholds for one or more attributes or relationships are reached.

22. The method as claimed in claim 20, further comprising placement of growth or other spatial change outside of the modeled area boundaries to visually quantify the amount of growth or spatial change after a threshold is exceeded.

23. The method as claimed in claim 20, further comprising establishing the likely future time when thresholds are triggered.

24. The method as claimed in claim 20, further comprising:
repeatedly re-inputting representative models to update a database of preferences; and
using the database of preferences to gather statistics or preferences for the adoption of the digital comprehensive plan and for developing additional digital models of scenarios.

25. The method as claimed in claim 2, further comprising:
reviewing or revising the adopted digital comprehensive plan to test actual or proposed changes in attributes and/or time; and
providing automated or manual feedback to the original model of changes in attributes, relationships or temporal conditions.

26. The method as claimed in claim 2, wherein the method of updating the digital comprehensive plan further comprises:
inputting additional data into the interface control module;
processing the additional data using the interface control module;
developing additional digital models of scenarios based on the additional processed data;
producing additional representative models of the additional digital models; or
accepting automatically provided and/or web linked data.

27. The method as claimed in claim 26, wherein the additional data can be input at any time after adopting digital comprehensive plan.

28. The method as claimed in claim 2, further comprising:
remotely sensing and acquiring data regarding past, current or impending events; and
using this data to direct the development of the digital models.

29. A system capable of modeling a past, present and/or future community development or plan that is self-contained and capable of direct updating, comprising:
an interface control unit for data input, process and data control, selection of a desired model and for outputting data;
a virtual comprehensive plan unit communicatively coupled to said interface control unit for receiving data from the interface control unit and producing one or mote models of scenarios for output;
a digital comprehensive plan module communicatively coupled to said virtual comprehensive plan unit for receiving output from the virtual comprehensive plan unit and producing representations of the models;
an output module communicatively coupled to said virtual comprehensive plan unit for receiving the representations from the digital comprehensive plan module and outputting a selected desired model; and
an optimization module communicatively coupled to said virtual comprehensive plan unit output module for receiving the selected desired model and allowing the system to gather statistics from data inputs and calculate possible trend.

30. The method as claimed in claim 29, wherein the interface control module comprises:
graphical user interfaces for receiving user inputs and outputting data;
a virtual comprehensive plan interface communicatively coupled to said graphical user interfaces for receiving data from the graphical user interfaces and outputting virtual comprehensive data;
a digital comprehensive plan interface communicatively coupled to said virtual comprehensive plan interface and said graphical user interfaces for receiving data from the graphical user interfaces, for receiving virtual comprehensive data from the virtual comprehensive interface and for outputting digital comprehensive data;
a digital comprehensive plan output interface communicatively coupled to said digital comprehensive plan interface for receiving digital comprehensive data from the digital comprehensive plan interface and outputting optimizable data;
a digital comprehensive plan learning interface communicatively coupled to said digital comprehensive plan interface for receiving digital comprehensive data from the digital comprehensive plan interface and outputting optimizable data;
a digital support system interface communicatively coupled to said digital comprehensive plan interface for receiving digital comprehensive data from the digital comprehensive plan interface and outputting optimizable data; and
an optimization interface communicatively coupled to said virtual comprehensive plan unit, the digital comprehensive plan output interface, the digital comprehensive plan learning interface and the digital support system interface for receiving optimizable data from the digital comprehensive plan output interface, the digital comprehensive plan learning interface and the digital support system interface.

31. A system capable of modeling a past, present and/or future community development or plan that is self-contained and capable of direct updating, comprising:
an interface control unit for data input, process and data control, selection of a desired model and for outputting data comprising:
graphical user interfaces for receiving user inputs and outputting data;
a virtual comprehensive plan interface communicatively coupled to said graphical user interfaces for receiving data from the graphical user interfaces and outputting virtual comprehensive data;
a digital comprehensive plan interface communicatively coupled to said virtual comprehensive plan interface and said graphical user interfaces for receiving data from the graphical user interfaces, for receiving virtual comprehensive data from the virtual comprehensive interface and for outputting digital comprehensive data;
a digital comprehensive plan output interface communicatively coupled to said digital comprehensive plan interface for receiving digital comprehensive data from the digital comprehensive plan interface and outputting optimizable data;
a digital comprehensive plan learning interface communicatively coupled to said digital comprehensive plan interface for receiving digital comprehensive data from the digital comprehensive plan interface and outputting optimizable data;
a digital support system interface communicatively coupled to said digital comprehensive plan interface for receiving digital comprehensive data from the digital comprehensive plan interface and outputting optimizable able data; and
an optimization interface communicatively coupled to said virtual comprehensive plan unit, the digital comprehensive plan output interface, the digital comprehensive plan learning interface and the digital support system interface for receiving optimizable data from the digital comprehensive plan output interface, the digital comprehensive plan learning interface and the digital support system interface;
a virtual comprehensive plan unit for receiving data from the interface control unit and producing one or more models of scenarios for output, comprising:
a spatial attribute calculator communicatively coupled to said interface control unit;
an event calculator communicatively coupled to said interface control unit and said spatial attribute calculator;
an impact calculator communicatively coupled to said interface control unit, said spatial attribute calculator, and said event calculator;
an output unit communicatively coupled to said event calculator;
a spatial attribute assessor communicatively coupled to said output unit;
an event assessor communicatively coupled to said output unit and said spatial attribute assessor;
an impact assessor communicatively coupled to said output unit and the event assessor;
a financial impact assessor communicatively coupled to said output unit and said impact assessor;
an resource assessor communicatively coupled to said output unit and said financial impact assessor;
a life quality assessor communicatively coupled to said output unit and said resource assessor;
a digital comprehensive plan unit communicatively coupled to the virtual comprehensive plan unit for receiving one ore more models of scenarios from the virtual comprehensive plan unit and producing representatives of the models for output;
a final output unit communicatively coupled to said digital comprehensive plan unit for receiving the representatives of the models and outputting a selected desired model, comprising:
a visualization module;
a user evaluation module communicatively coupled to said visualization module; and
a decision support module communicatively coupled to said user evaluation module;
an optimization module communicatively coupled to said virtual comprehensive plan unit and said final output unit for receiving the selected desired model and allowing the system to gather statistics from data inputs and to calculate possible trends, comprising:
a digital comprehensive plan catalog module communicatively coupled to said final output unit;
a learning module with threshold cognizance communicatively coupled to said digital comprehensive plan catalog module; and
a value trend module communicatively coupled to said learning module; and
a review module communicatively coupled to said final output unit for receiving the selected desired model and reviewing any results of the system
a review module communicatively coupled to said final output unit for receiving the selected desired model and reviewing any results of the system.
